(19) United States
(12) Patent Application Publication
(10) Pub. No.: US 2026/0133594 A1
(43) Pub. Date: May 14, 2026

(54) CONTROLLER USING FLOW ENTRY POINT DETECTION

(71) Applicant: BELIMO HOLDING AG, Hinwil (CH)

(72) Inventors: Babak MOHAJER, Zürich (CH); Forest REIDER, Hinwil (CH)

(21) Appl. No.: 19/120,983

(22) PCT Filed: Oct. 10, 2023
(86) PCT No.: PCT/EP2023/078003

§ 371 Date: Apr. 14, 2025

(30) Foreign Application Priority Data
Oct. 14, 2022 (CH) 001219/2022
Nov. 14, 2022 (CH) 001355/2022

(51) Int. Cl. G05D 7/06; G05B 19/042

(52) U.S. Cl. CPC G05D 7/0635; G05B 19/042; G05B 2219/2614

(57) ABSTRACT

A flow controller for use in a HVAC system includes a control unit for controlling at least one of a flow rate and power of a fluid passing through an opening of a flow regulating element The opening position of an actuator for opening/closing the flow regulating element is adjustable by the control unit. The flow controller is configured for determining a flow entry point position of the actuator. The control unit is configured for applying a first control method for controlling the actuator position when the actuator position is below the flow entry point position, and for applying a second control method for controlling the actuator position when the actuator position exceeds the flow entry point position.

### TECHNICAL FIELD

The application relates to a controller for use in a HVAC (Heating Ventilation Air Conditioning) system.

### BACKGROUND

In the field of heating, ventilation and air-conditioning systems (HVAC) of buildings, ships and trains, in particular residential buildings, office buildings, commercial buildings and industrial buildings, automatic fluid flow measurement and regulation becomes more and more important. These HVAC systems comprise a plurality of field devices, e. g. actuators, sensors, or combinations thereof. Particularly, modern water or other medium based heating or cooling systems use flow control loops, and it is preferred using pressure independent flow control, of fluid flowing through adjustable valves.

However, it appears that the quality of the flow control is not satisfactory, since the relation between an actuator position (referring to an opening position of a regulating element like a valve or a damper, i.e. a temporary setting of the opening of the adjustable element) and the flow flowing through the opening of the regulating element is nonlinear. Particularly, when a valve or damper opening position has small values (i.e. the set opening size is small) at the beginning of an opening process of the valve or dampener, fluid only starts flowing through the valve or damper after a certain position of the actuator has exceeded a certain reference position. This position is called “flow entry point position”. In conventional systems opening from a closed position takes a long period of time until the actuator reaches the flow entry point position and even more to reach a given flow set-point. In conventional closed loop control (e.g. temperature control cascaded with flow control) integral windup can lead to oscillations or instability in the system. But even without cascaded control it takes quite long until the flow entry point position is reached. Instability may additionally occur if there is a superior controller with an integral part that realizes it does not get enough flow and therefore continues to integrate. In fact, only after the actuator position referring to a valve opening position or damper opening position has exceeded the flow entry point position, there is a defined stable relation between the opening valve position and the rate of water flowing through the adjustable control valve (or any other controlled variable). At actuator positions around the flow entry point position the relation between the opening position and the controlled variable (e.g. flow rate through the valve) tends to be instable.

In addition, due to manufacturing tolerances the flow entry point position varies and is individual for each valve-actuator combination (including e. g. a gear between a flap and the actuator drive). The flow entry point position may typically be between 7-20% off the complete closing position of the actuator, or even higher. Therefore, the quality of controlling the flow rate may differ from valve to valve although using the same controller.

### SUMMARY

It is an object of the present disclosure to provide a controller for a HVAC system and a method for operating the controller having improved response time. Systems of the present disclosure may include: a control unit for controlling at least one of a flow rate and power of a fluid passing through an opening of a regulating element, a differential pressure in the HVAC system and absolute pressure on a point of the HVAC system, wherein the opening position of the regulating element is adjustable by the control unit. Furthermore, the present disclosure relates to a method for controlling a valve in a HVAC system, particularly by using a controller for use in a HVAC system comprising: a control unit for controlling at least one of a flow rate, power of a fluid passing through an opening of the regulating element, a differential pressure in the HVAC system and absolute pressure on a point of the HVAC system, wherein the valve opening position is adjustable by the control unit.

A controller for use in a HVAC system according to the present disclosure comprises: a control unit for controlling a controlled variable including at least one of a flow rate, power of a fluid passing through an opening of a regulating element, a differential pressure in the HVAC system and absolute pressure on a point of the HVAC system, wherein the opening position of the regulating element is adjustable by an actuator which is controlled by the control unit. The control unit is configured for applying a first control mode or a second control mode depending on an actuator position and/or a value of the controlled variable of the system.

The regulating element may be a valve, a damper, or any other element having an adjustable opening for limiting, reducing, opening and closing, respectively, the rate of fluid flowing through the regulating element.

The controlled variable may be a flow rate (mass or volume per time unit) of fluid, power (energy per time unit) of fluid flowing through the regulating element, an absolute pressure in point of the HVAC network, a differential pressure in a branch of a fluid transportation network, or similar characteristic of a HVAC system. The controlled variable may be a measured variable or a setpoint value.

The fluid used in the HVAC system may be any suitable medium, e.g. water, water/glycol mixtures, air, refrigerants etc.

The control unit may control the flow rate (mass/time, volume/time) or the power (energy/time=energy rate) of a fluid passing through the regulating element, e.g. the valve.

Any actuator position refers to an opening position of the regulating element and a value of the controlled variable, respectively, e.g. a particular value of a flow rate, a particular value of power of a fluid passing through an opening of a regulating element, a particular value of differential pressure in the HVAC system and/or absolute pressure on a point of the HVAC system. I.e. there is a relation between an actuator position and an opening position of the regulating element and/or the controlled variable. The relation may e.g. be functional or a hysteresis.

In a first preferred embodiment of the present disclosure the control unit is configured for controlling the position of the actuator when the position is in a region below a reference position using the first control mode, and for controlling the position of the actuator when the position is in a region exceeding the reference position using the second control mode.

It is preferred that the reference position corresponds to a flow entry point position and/or a flow closing point position of the actuator. For example, the actuator position may be a rotary angle of a rotary actuator which corresponds to an opening angle/opening size of the regulating element.

In order to overcome the difficulties of prior art systems a flow entry point position is determined by the controller. The flow entry point position (or correspondingly, the flow closing point position) may be determined and adjusted in every opening-closing cycle of the valve, and then be used for controlling the next or any subsequent opening-closing cycle. The flow entry point position is an actuator position referring to the opening position of a valve at which (measurable) flow begins passing through the valve when opening the valve. Correspondingly, the flow closing point position is the position of the actuator referring to the opening position of a valve at which flow stops passing through the valve when closing the valve. The flow entry point position and the flow closing point position of a particular valve (under particular conditions of the system) may be the same, or they may be different from each other due to backlash/hysteresis effects.

By determining and adjusting the flow entry point position and/or the flow closing point position the actuator may be driven (when opening the valve) to a certain extent, i.e. until reaching the flow entry point position, rapidly and without feedback of the controlled variable, e.g. flow, pressure, power, flow difference, etc. Particularly, below the flow entry point position the operation mode may be a position control mode, e.g. driving an actuator for opening the regulating element at the highest actuator speed to the flow entry point position. In this phase of control there is no flow until the flow entry point position has been reached, so the system pressures or temperatures will not be affected. In this way long opening times like in prior art systems may be avoided. After a certain value, namely, the flow entry point position, has been reached normal flow control operation may be started, e.g. feedback control. The following drawbacks of the prior art may be reduced considerably or be eliminated:
Fluctuations due to less stable control in the low flow region of the valve may be avoided.
Long opening and closing times due to slowly moving the actuator in the zero flow or low flow region of the valve may be avoided.
Low reactivity and long response time each time the controller starts opening the valve and effects due to hysteresis at low flow may be avoided.
Deviations resulting from manufacturing tolerances of the valve may be compensated,

In a preferred embodiment of the present disclosure the first control method may be a simple constant and/or high speed movement of the actuator when opening of the valve, thereby reducing the duration of the opening process, e.g. by setting a constant speed setpoint or a position setpoint of the actuator. The second method may be any kind of flow control like feedback control that reacts on changes of the conditions (e.g. pressure changes) in the HVAC system, in order to keep the controlled variable at a given setpoint value and compensate for system fluctuations.

The first control method may be a feed forward control, and the second control method may be a feedback control.

In a preferred embodiment of the present disclosure the controller comprises a finite state machine for switching between the first control method and the second control method. In particular, the finite state machine switches between a feed forward control, a feedback control and a closed valve position (wherein the valve is closed to a valve opening position of 0%). To ensure there is no leakage when no flow is desired, the valve must fully close, if zero flow is requested (go to 0% position).

Furthermore, the controller may comprise an observer and estimator unit for determining the flow entry point position and/or the flow closing point position for using the value when controlling a next or subsequent opening-closing cycle.

It is preferred that the flow controller is configured for determining the flow entry point position adaptively. This means the controller learns the flow entry point position of an individual valve-actuator combination (including a flap, valve, actuator and/or gear) from cycle to cycle. Whereas in a first opening-closing cycle after a first installation of a valve the opening time may be quite long, it becomes shorter after the first learning cycle, and more and more accurate from learning cycle to learning cycle.

In another embodiment of the present disclosure the flow controller may be configured for updating the flow entry point position repeatedly. The flow entry point position and/or the flow closing point position may be updated e.g. in every opening-closing cycle and be used for the next or subsequent opening-closing cycle(s).

In another preferred embodiment of the present disclosure the control unit is configured for controlling the actuator position and/or the controlled variable of the system using the first control mode when the actuator position or the value of the controlled variable of the system is below a reference value, and for controlling the actuator position and/or the controlled variable of the system of the system using the second control mode when the actuator position or the controlled variable of the system is above the reference value. The reference value may be a particular position (e.g. angle) of a rotary actuator.

In a second preferred embodiment of the present disclosure the control unit is configured for determining whether a setpoint of the controlled variable of the system is below or above a reference value, and when it is in a region below the reference value using the first control mode, and when it is in a region exceeding the reference value using the second control mode.

The control unit may be configured for changing from a first control mode to a second control mode when the setpoint of the value of the controlled variable exceeds a first reference value, and for changing from the second mode to the first mode when the setpoint of the controlled variable is below a second reference value and the (measured) value of the controlled variable is below a third reference value.

The first reference value and the second reference value may be the same or they may be the different. The second reference value and the third reference value may be the same or they may be different.

In another preferred embodiment of the present disclosure the control unit comprises a low-flow hysteresis unit. It is determined whether the setpoint of the controlled variable is below or above a reference value. As a consequence, the control unit changes the control method when the setpoint of the controlled variable exceeds the reference value.

The controlled variable may be e.g. a flow rate, a pressure difference, a power value or another variable characterizing the state of the system. A hysteresis module may be applied to the setpoint of the controlled variable. The output value of the hysteresis module may correspond to a setpoint of the controlled variable or a position of the actuator (opening position) for opening/closing the regulating element.

When opening e.g. a valve, the output value of the hysteresis module may be zero (e.g. a corrected flow setpoint or an actuator position, both corresponding to flow=0 l/min) if the setpoint of the controlled variable is below the first reference value, and it may follow a functional relation (e.g. linear increasing function) when the actuator position corresponding to the controlled variable or the setpoint of the controlled variable exceeds the first reference value.

When closing e.g. the valve, the output value of the hysteresis module may be a constant value (e.g. a corrected flow setpoint or an actuator position corresponding to a setpoint limit>0 l/min), if the setpoint of the controlled variable is below the second reference value, and it may be zero if the setpoint of the controlled variable is below a fourth reference value. The fourth reference value may be smaller than the second reference value.

The controller may comprise a leakage avoidance control unit which closes the valve completely when no flow is desired.

The object of the present disclosure is also attained by providing a method for controlling a valve in a HVAC system, particularly by using a controller as described before, wherein the method comprises the following steps:
(a) Determining a position of an actuator and/or a value of a controlled variable of the system and setting a reference value of the position of an actuator and/or a reference value of the controlled variable;
(b) Controlling the position of an actuator of the regulating element and/or the controlled variable of the system using a first mode, when the position of the actuator and/or the value of the controlled variable is in a region below the reference value, and controlling the position of the actuator of the regulating element and/or the controlled variable of the system using a second mode, when the parameter and/or the value of the controlled variable is in a region above the reference value.

The first mode may comprise position control, like feed forward control, and the second mode may comprise flow control, e. g. feedback control.

As described above the reference value may be a flow entry point position or a flow closing point position.

Step (a) may include determining a position of the actuator referring to an opening position of the regulating element and setting a flow entry point position and/or a flow closing point position of the actuator as the reference value.

The method may comprise determining the flow entry point position and/or the flow closing point position adaptively and/or repeatedly.

The first mode may include driving the actuator when opening the regulating element at a predetermined speed as long as the opening position of the regulating element is in a region below the flow entry point position, and controlling the movement of the actuator when opening of the regulating element in the second mode using flow control when the opening position is in a region above the flow entry point position. The speed of the position control may be constant or non-constant, i.e. a speed profile.

The method may comprise a step of determining the flow entry point position and/or the flow closing point position, calculating the mechanical backlash of the regulating element and compensating the backlash during operation of the regulating element. The backlash may include a backlash of a gear and/or of a coupling between the actuator output and the regulating element.

In a preferred embodiment of the present disclosure, when the position of the actuator is determined to decrease from a value above the reference value of the position of the actuator to the reference value of the position of the actuator, maintaining the position of the actuator substantially at the reference value at least for a predetermined time period. In other words, when closing the regulating element, the actuator is just removed into a position at or slightly below the reference value (e.g. flow entry point), thus allowing fast responsive times when re-opening the regulating element.

“Substantially” means that the position may be a position at or slightly below the reference value of the position of the actuator such that there is no flow through the regulating element, but the position of the actuator is in a small range below the reference value compared to the range between “zero” (full closing) position and the reference value. The predetermined time period may be a period in which a there is a certain likelihood of an increase of the position of the actuator above the reference value. A typical period may be some minutes, e.g. 15 minutes.

Maintaining the position of the actuator at the reference value (e.g. flow entry point position) for the time period allows fast actuation and reaction of the regulating element when there is need for actuator positions above the reference value within the time period.

Furthermore, the method may include using the second mode for controlling the position of the actuator of the regulating element immediately when the position of the actuator of the regulating element increases and exceeds the reference value within the predetermined time period. Within the predetermined time period the position of the actuator is not reduced to “zero” or full closing position, but is maintained at a position where flow is substantially zero, but could be activated within short time to a value exceeding zero flow corresponding to an actuator position exceeding the reference value.

In preferred embodiment of the present disclosure the method may include decreasing the position of the actuator of the regulating element to a position below the reference value after expiry of the predetermined time period when the position of the actuator has been maintained at the reference value for the predetermined time period. After expiry of the time period, the valve returns to a “zero” position or full closing position in order to avoid small flow of fluid or bubbles passing the fluid from passing the regulating element.

In another embodiment of the method the first mode may include maintaining a predetermined setpoint value of the controlled variable by means of the actuator position when the setpoint is below the reference value of the controlled variable, and the second mode includes using flow control of the controlled variable by means of the actuator position.

Particularly, the method may include using low flow hysteresis for controlling the actuator position in the first mode and the second mode, respectively. Step (a) may comprise determining by comparison of a hysteresis loop and a given setpoint whether the setpoint is below or above the reference point. After the determination the kind of control method is selected by an algorithm.

In a preferred embodiment the method may include changing from a first control mode to a second control mode when the setpoint of the controlled variable exceeds a first reference value, and for changing from the second mode to the first mode when the setpoint of the controlled variable is below the second reference value and/or the (measured) value of the controlled variable is below a third reference value. The measured value of the controlled variable and the reference value may be flow rate values, and the setpoint value may be a set value of a flow rate input into the controller. The first reference value and the second reference value may be the same or they may be the different. The second reference value and the third reference value may be the same or they may be different.

The controlled variable may adopt a measured value or a setpoint value.

As a result, the controller and the method provide higher reactivity and lower response time each time control of the flow rate through the valve is started. Furthermore, the flow entry point position is adaptively determined for each individual valve-actuator combination, thus compensating variations of the flow entry point position resulting from manufacturing tolerances and effects of product ageing. The flow entry point position may be continuously and individually determined and updated (e.g. depending on the environmental conditions such as varying system pressures) for each individual valve.

### BRIEF DESCRIPTION OF THE DRAWINGS

The present disclosure will be explained in greater detail with reference to the exemplary embodiments which are illustrated in the drawings.

FIG. 1 is a diagram showing the flow rate of water flowing through a valve in relation to the opening position of a valve actuator;

FIG. 2 is a schematic illustration of a first embodiment of a controller according to the present disclosure;

FIG. 3 is a schematic illustration of a second embodiment of a controller according to the present disclosure;

FIG. 4 is a schematic illustration of a low flow hysteresis loop;

FIG. 5 is a diagram illustrating a closing and re-opening process of a valve using an improved algorithm.

### DETAILED DESCRIPTION

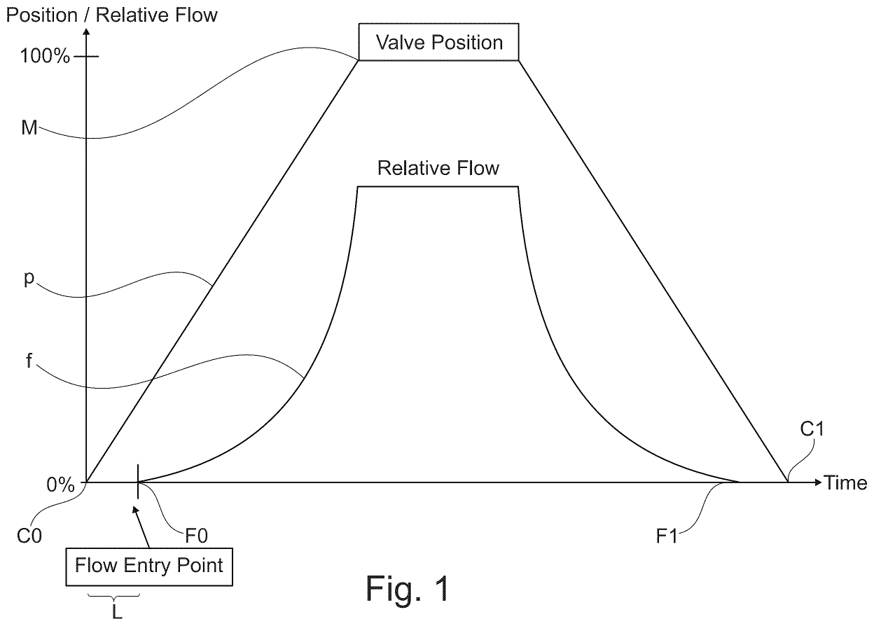

The diagram of FIG. 1 illustrates the flow characteristics of a typical valve, e.g. a ball valve, operated in a HVAC circuit. The valve opening position p (corresponding to an actuator position of the valve actuator) increases linearly from a closed position C0 to a maximum value M. The flow f of water flowing through the valve opening begins at a time F0 with a first delay between C0 and F0. The value of the valve opening position (absolute or relative value) at time F0 is the flow entry point position. In the example the flow entry point position of the actuator is a value of ca. 10% of the position of the actuator referring to the maximum opening M of the valve.

It can be seen that the relation between the valve opening position and the flow is strongly non-linear in the low flow region L. When opening the valve at C0 the flow starts at flow entry point position F0. After the position p has passed the flow entry point position the flow f increases leaving the low flow region behind.

When closing the valve by decreasing the valve opening position p, the flow f reaches a value of zero at a time F1 which is before the actuator position is a position referring to complete closure (“zero”) of the valve is completely closed at time C1. There is a second delay between F1 and C1 which may be equal or different from the first delay. The actuator position F1 is the flow closing point position. It may be equal to or different from the flow entry point position.

It is a relevant feature that a controller of a valve according to the present disclosure detects and determines the flow entry point position. The controller may use a learning algorithm in order to determine the flow entry point position for each valve individually, to check it continuously and adapt it if necessary. In this way, the valve can turn from the closed state to the flow entry point position at the fastest actuator speed (or valve speed) during the opening phase and continue controlling the valve opening position p (depending on the measured flow f) safely and stably from thereon. I.e. the present disclosure provides fast and stable control immediately when the valve opening process begins, the algorithm adapts to the flow characteristics of the valve and the ambient conditions in the HVAC system during operation by continuous detection and correction.

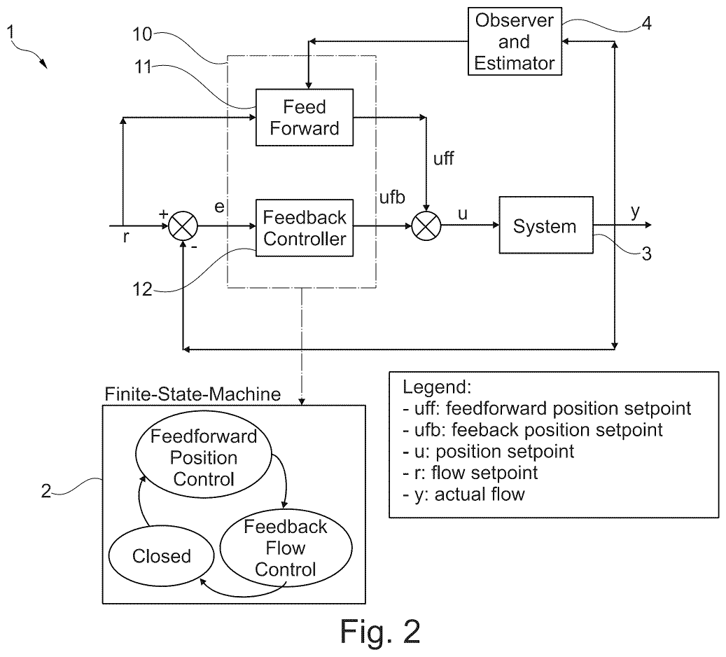

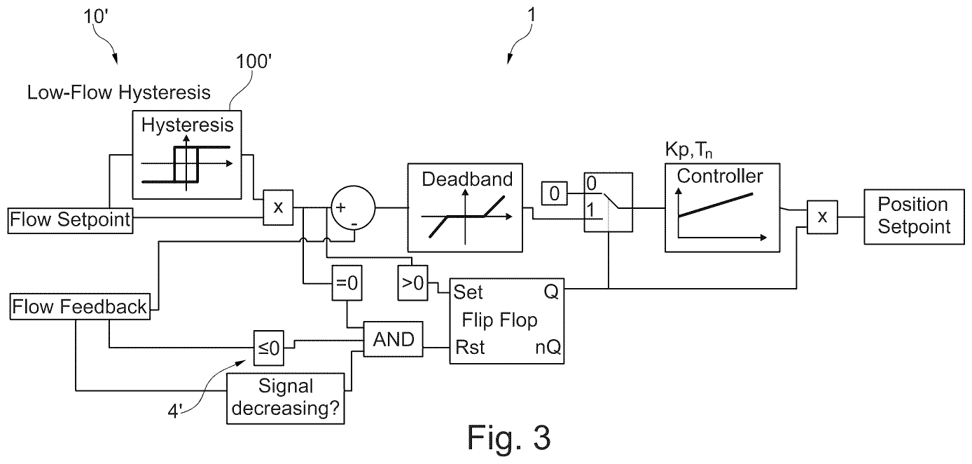

In particular, the controller can determine the flow entry point position at the beginning of a cycle (opening-closing; states: closed-open-closed) using the ascending portion of the diagram of FIG. 1, or at the end of the cycle using the descending portion of the diagram of FIG. 1, and store the value(s) in a memory. The value(s) can be used for controlling the opening process in a subsequent cycle, e.g. by using any of the control methods shown in FIGS. 2 and 3. In addition, the values can also be used to determine the hysteresis of the actuator-valve system.

FIG. 2 depicts a first embodiment of a controller 1 according to the present disclosure for controlling a valve 3 in a HVAC system. The controller 1 is an observer-based feed forward and feedback-loop flow controller 1. The flow control scheme comprises three instances: a feed forward control, a feedback control, and an observer-based state estimator feedback. Therefore, the controller 1 comprises a control unit 10 having a feed forward controller 11 and a feedback controller 12. A finite state machine 2 is configured for switching between the feed forward controller 11, the feedback controller 12 and a closed position. The feedback control is based on a given setpoint r of a controlled variable (here a flow setpoint) and a difference value e (e=r−y). The setpoint u applied to the actuator of the valve 3 is either a feed forward position setpoint (uff) or a feedback position setpoint (ufb). The flow setpoint r is a given/set value provided to the controller 1. An actual flow y may be detected and used for the control of the valve 3.

According to the present disclosure, when a flow setpoint r is higher than a defined threshold (e.g. 0%) the flow controller 1 first switches to feedforward position control 11 to reach the flow entry point position with the fastest speed. After ensuring that there is measurable flow y within the pipe, the controller switches to the feedback-loop control 12.

At this step, an observer and estimator 4 estimates the actuator position at which the flow is being measured and compares this position with previously estimated positions. In case of a deviation (e. g. due to changing environmental conditions) the estimator 4 updates the flow entry point position for the next opening phase. The updated flow entry point positions are stored in a memory. For example, the flow entry point position may be updated each time the estimation takes place and a new flow entry point position according to the new environmental conditions of the valve has been estimated. In the very first opening of the valve, the algorithm opens the valve to see which is the actuator position in which there will be a measurable flow. This position will be stored a s an internal variable. Subsequently when the valve closes, a closing point will be estimated, which is the actuator position of the valve where there will be no measurable flow. This flow closing point position is a new internal variable which may be integrated in the low flow hysteresis logic or update the prior internal variable with the newly detected flow closing point position. In general, it is the idea of the present disclosure that the next time the valve opens, it moves with its fastest speed to the flow entry point position, thus gaining reactivity and stability. Backlash and delay effects are compensated by moving/driving the actuator at high speed to the flow entry point position. The comparison, estimation and adjustment between the actuator position and measured flow entry point position (flow closing point position) may be performed during the opening phase and/or during the closing phase of the valve 3.

At the very first opening of the valve 3 after the installation of the valve 3 in a plant, the controller 1 starts the feed forward controller 11 which controls the valve opening position to open the valve to an initial pre-defined position and then switches to the feedback-loop flow controller 12 until the observer and estimator 4 estimates the valve specific flow entry point position. This learning process can be repeated and the flow entry point position may be updated from cycle to cycle thereby decreasing the valve opening time.

In order to ensure there is no leakage when no flow is desired, the controller 1 makes the valve 3 close completely (go to 0% valve opening position) at the end of each cycle.

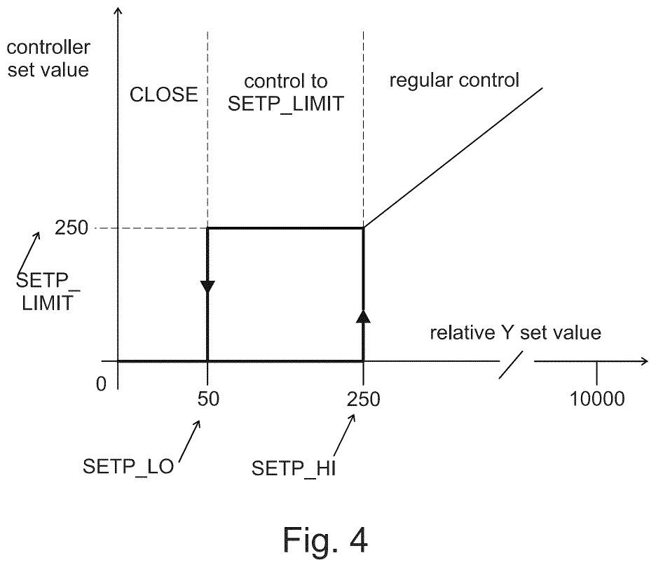

FIG. 3 depicts a second embodiment of the present disclosure. Corresponding elements are designated with the same reference numbers as in FIG. 2. The controller 1 is a low flow hysteresis based controller design. The controller 1 implements a control unit 10′ which includes a low flow hysteresis as described with reference to FIG. 4.

FIG. 4 depicts a diagram illustrating low flow hysteresis applied to a setpoint of the controlled variable, e. g. a flow setpoint. Low flow hysteresis is applied in order to avoid that for very small setpoints the valve starts opening (e. g. in case of analogue setpoint and some noise on the analogue signal). In fact, if the external setpoint rises, but is still below the value SETP_HI (first reference point or reference value), the setpoint for the controller remains at 0. Above SETP_HI, the external setpoint is directly mapped to the controller setpoint. In the decreasing direction, the controller setpoint remains at SETP_LIMIT as long as the external setpoint is between SETP_HI and SETP_LO. If the external setpoint is below SETP_LO (second reference point or reference value), the controller setpoint goes to 0. In this example, the low flow hysteresis refers to defined threshold values, like SETP_HI, SETP_LO and SETP_LIMIT.

When opening the valve of FIG. 3 (signal increasing), the flow controller 1 receives a flow setpoint. If the setpoint of the controlled variable (e.g. flow rate) is lower than a first threshold value recorded in the hysteresis loop 100′, the value output by the control unit 10′ remains zero. In other words, the setpoint is multiplied by 0 in the controller 1, so the output setpoint value in the control unit 10′ is 0 (zero).

When the setpoint reaches the first threshold value, the output of the low flow hysteresis loop 100′ generates a corrected flow setpoint, e.g. 2 l/min. From thereon it is controlled by regular flow control, e.g. by feedback control. If the mechanical backlash is known or has been determined, it can be applied here as well, to directly move to the opening position (e.g. 7° position of the valve).

When the valve is closed (signal decreasing), if the setpoint of the controlled variable (e.g. flow rate) is lower than the first threshold value, the setpoint remains at the first reference value >0 (e.g. corresponding to 7° position of the valve). If the signal falls below a second threshold value (smaller than the first threshold value), the setpoint is changed to zero, and from thereon the valve actuator goes into 0° position (completely closed).

It can be seen that the hysteresis is distinct for increasing and decreasing values of the controlled variable as well as between setpoint values above and below different reference values. The control mode depends on the controlled variable and the reference values. The corresponding algorithm is implemented by a circuit as shown in FIG. 3.

In particular, the control circuit of FIG. 3 comprises a Flip-Flop and a memory for storing an integral value. When switching from “1” to “0”, the integral value is stored. When switching from “0” to “1”, the stored value is resumed as an initial value. For example, when the Flip-Flop outputs “0”, the setpoint of the actuator is 0° and integration is suspended. When it outputs “1”, the setpoint of the actuator changes to a stored angle, e.g. 6°, and integration is resumed. In the closing phase, the controller freezes and preserves the point at which no flow is measured (flow closing point). In the next opening phase, the controller will start to move the actuator to the detected flow closing point with its fastest speed. With this approach the entry point detection takes places automatically during the closing phase via controller design. The measured flow closing point position is a new internal variable which may be integrated in the low flow hysteresis logic or update the prior internal variable with the newly detected flow closing point position.

The method described in FIG. 3 may be combined with measuring and updating the flow entry point position and flow closing point position, respectively, e.g. for updating reference values or preserving the flow closing point position when closing the valve.

In the above described embodiments the flow entry/closing point position may be detected every time when opening the valve and/or when closing the valve. This facilitates on-going learning and updating the flow entry/closing point position for each individual valve-actuator combination and depending on the environmental conditions such as varying system pressures.

Furthermore, a safety margin may be applied, whereby the valve can reach the flow entry (closing) point position with the highest speed provided by the actuator without any danger of introducing instability in the system. Whereas the opening phase takes a long time in conventional controls, the inventive controller reaches the requested flow as fast and as robust as possible.

Furthermore, when opening the valve from the closed position (C; valve opening position 0%), the actuator position may change at a nominal speed without any feedback control and, after passing the flow entry (closing) point position, closed-loop control may be started and maintained.

The inventive controller and the corresponding methods facilitate high reactivity and low response time whenever the valve has to be opened from a fully closed position.

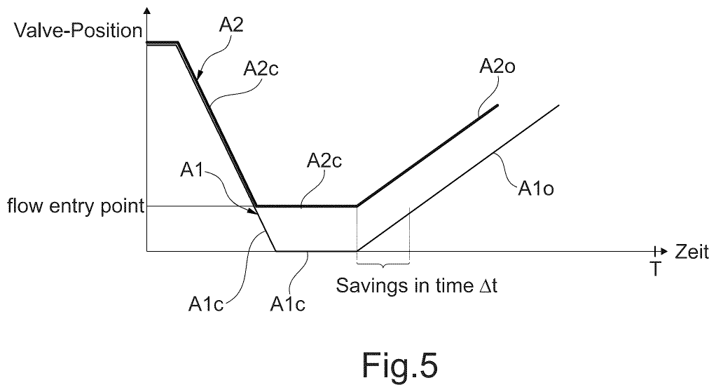

FIG. 5 depicts a closing and re-opening process of a valve using a first (regular) algorithm and a second enhanced algorithm, respectively.

When using the first algorithm depicted in a first function A1, the actuator position follows a linearly declining control signal A1c until the actuator position reaches a “zero” position wherein the valve is completely closed. When re-opening the valve according to the control signal A1o, the actuator position has to be moved until the flow entry point is reached. Afterwards, further increasing the actuator position linearly, the valve opens and fluid begins flowing through the valve, e.g. until a certain setpoint value of the actuator position has been reached.

When using the second algorithm depicted in a second function A2, the actuator position follows a linearly declining control signal A2c until the actuator position reaches a position corresponding to the flow entry point or slightly below the flow entry point, i.e. a position wherein the valve is closed, but the actuator is not in a fully closed “zero” position. When re-opening the valve according to the control signal A2o within a predetermined time period T, the actuator position increases, the valve opens immediately after the re-opening signal is received and fluid begins flowing through the valve, e.g. until a certain setpoint value of the actuator position has been reached.

It can be understood from a comparison of the functions A1 and A2, that using the second algorithm has a better response time when re-opening the valve. The time saved in the re-opening process is designated At.

1-26. (canceled)

27. A controller (1) for an HVAC system, the controller comprising:
a control unit (10, 10′) configured to control a controlled variable including at least one of a flow rate, power of a fluid passing through an opening of a regulating element (3), a differential pressure in the HVAC system, and absolute pressure at a point of the HVAC system;
wherein the opening position of the regulating element is configured to be adjustable by an actuator which is controlled by the control unit (10, 10′); and
wherein the control unit (10, 10′) is configured to apply a first control mode or a second control mode depending on an actuator position.

28. The controller of claim 27, wherein the first control mode is a feed forward control (11), and the second control mode is a feedback control (12).

29. The controller of claim 27, wherein the controller (1) comprises a leakage avoidance control unit.

30. The controller of claim 27, wherein the control unit (10, 10′) is configured to apply the first control mode or the second control mode based on the actuator position relative to a reference position which corresponds to a flow entry point position and/or a flow closing point position of the actuator.

31. The controller of claim 30, wherein:
the controller (1) comprises an observer and estimator unit (4) configured to determine the flow entry point position and/or the flow closing point position for using the flow entry point position and the flow closing point position, respectively, in controlling at least one subsequent opening-closing cycle of the regulating element (3).

32. The controller of claim 30, wherein:
the controller (1) is configured to determine the flow entry point position and/or the flow closing point position adaptively.

33. The controller of claim 32, wherein the controller is configured to update the flow entry point position repeatedly.

34. A controller (1) for an HVAC system, the controller comprising:
a control unit (10, 10′) for controlling a controlled variable including at least one of a flow rate, power of a fluid passing through an opening of a regulating element (3), a differential pressure in the HVAC system, and absolute pressure at a point of the HVAC system, wherein the opening position of the regulating element is adjustable by an actuator which is controlled by the control unit (10, 10′),
wherein the control unit (10, 10′) is configured to apply a first control mode or a second control mode depending on a value of the controlled variable of the system,
wherein the control unit (10′) is configured to change from a first control mode to a second control mode in response to a setpoint of the controlled variable exceeding a first reference value, and for changing from the second control mode to the first control mode in response to the setpoint of the controlled variable falling below a second reference value and a value of the controlled variable falling below a third reference value.

35. The controller of claim 34, wherein the controller is configured to store the actuator position in response to the controlled value falling below the third reference value, the actuator position corresponding to the flow closing point position of the actuator.

36. The controller of claim 35, wherein the control unit (10′) comprises a low-flow hysteresis unit for determining whether the setpoint of the controlled variable is below or above any of the reference values.

37. A method for controlling a regulating element (3) in an HVAC system by using a controller (1) for an HVAC system, the controller comprising a control unit configured to control a controlled variable including at least one of a flow rate, power of a fluid passing through an opening of a regulating element (3), a differential pressure in the HVAC system, and absolute pressure at a point of the HVAC system, wherein the opening position of the regulating element is adjustable by an actuator which is controlled by the control unit, wherein the method comprises:
(a) determining a position of an actuator and/or a value of a controlled variable of the system and setting a reference value of the position of an actuator and/or a reference value of the controlled variable;
(b) controlling the position of the actuator of the regulating element (3) and/or the controlled variable of the system, using a first mode, when the position of the actuator and/or the value of the controlled variable is in a region below the reference value, and controlling the position of the actuator of the regulating element (3) and/or the controlled variable of the system, using a second mode, when the position of the actuator of the regulating element (3) and/or the value of the controlled variable is in a region above the reference value;
wherein step (a) includes determining at least one of a flow entry point position and a flow closing point position of the actuator of the regulating element (3).

38. The method according to claim 37, wherein in step (a) the at least one of the flow entry point position and the flow closing point position of the actuator of the regulating element is set the reference value.

39. The method of claim 37, wherein the method comprises determining the flow entry point position and the flow closing point position, respectively, adaptively and/or repeatedly.

40. The method of claim 37, wherein the first mode includes:
moving the actuator at a predetermined speed as long as the opening position of the actuator is in a region below the flow entry point position, and
controlling movement of the actuator using flow control when the opening position of the actuator is in a region above the flow entry point position.

41. The method of claim 37, further comprising:
determining the flow entry point position and/or the flow closing point position;
calculating a mechanical backlash of the regulating element (3);
and compensating the backlash during operation of the regulating element (3).

42. The method of claim 37, wherein:
in response to the position of the actuator being determined to decrease from a value above the reference value of the position of the actuator to the reference value of the position of the actuator, maintaining the position of the actuator substantially at the reference value at least for a predetermined time period;
wherein the method includes using the second mode for controlling the position of the actuator of the regulating element (3) immediately when the position of the actuator of the regulating element (3) increases and exceeds the reference value within the predetermined time period.

43. The method of claim 37, wherein the first mode comprises feed forward control and the second mode comprises feedback control.

44. The method of claim 37, wherein the first mode is a position method and the second mode is a flow control method.

45. The method of claim 37, further comprising:
changing from the first mode to the second mode in response to a setpoint of the controlled variable exceeding a first reference value; and
changing from the second mode to the first mode in response to the setpoint of the controlled variable falling below a second reference value and the value of the controlled variable falling below a third reference value.

46. The method of claim 37, further comprising:
using low flow hysteresis for controlling the actuator position and/or a setpoint value of the controlled variable in the first mode and the second mode, respectively.
